(19) United States
(12) Patent Application Publication
(10) Pub. No.: US 2008/0086696 A1
(43) Pub. Date: Apr. 10, 2008

(54) System and Method for Using Virtual Environments

(75) Inventors: Bhargav Sri Prakash, Ann Arbor, MI (US); Scott C. Doerrfeld, Ann Arbor, MI (US); Jason D. Brown, Howell, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: CADcorporation.com Inc., Ann Arbor, MI (US)

(21) Appl. No.: 11/949,313

(22) Filed: Dec. 3, 2007

Related U.S. Application Data
(63) Continuation-in-part of application No. 11/368,038, filed on Mar. 3, 2006.

(51) Int. Cl. G06F 3/048

(52) U.S. Cl. 715/757

(57) ABSTRACT

A method for interfacing with a virtual environment provided by an operation module is disclosed. The method includes the steps of providing a participant computer terminal to permit a participant to interface with the virtual environment by way of a participant avatar; providing an agent computer terminal to permit an agent to interface with the virtual environment by way of an agent avatar; and providing an avatar navigation selection module that permits said participant to have an option of selecting one of a plurality of virtual environment avatar navigation modes including an independent, self control mode, a surrender-to-agent control mode, and a partial surrender-to-agent control mode.

### CROSS-REFERENCE TO RELATED APPLICATIONS

This application is a continuation-in-part of application U.S. Ser. No. 11/368,038 filed Mar. 3, 2006, which is incorporated herein by reference in its entirety.

### TECHNICAL FIELD

The present disclosure relates to a system and method of utilizing interactive graphics. According to an embodiment, the use of interactive graphics may be directed to a virtual environment (i.e. three-dimensional, 360-degree virtual reality imaging). According to an embodiment, the interactive graphics may be utilized for recruiting one or more persons for membership, employment, admission, or the like into an organization, such as, for example, an institute of education, a corporation, a professional society, a club, or the like. According to an embodiment, the interactive graphics may be utilized for soliciting and securing gifts from potential donors to a non-profit organization, educational institution, and other donor worthy organizations.

### BACKGROUND

Recruiting persons (i.e., “candidates”) for membership, employment, or admission is a critical aspect to the success, image, and/or public perception of an organization or institution. The person, entity, or agent who seeks candidates directly, or, on the behalf of the organization, is typically referred to as a “recruiter.” Typically, information available to the candidate about the organization is conveyed by way of printed materials, video, film, or electronically, for example, by way of the Internet. On the other hand, information available to the organization/recruiter about the candidate is limited and typically conveyed by way of a resume, grade transcripts, one or more personal references provided by the candidate, background checks, and the like.

The Internet increases the reach and efficiency of an information seeker while decreasing the disseminating costs of the information provider. With respect to recruiting techniques, it is clear that both the organization/recruiter and candidate may mutually benefit by taking advantage of the Internet's capabilities of disseminating and receiving information, respectively.

Regarding, for example, the recruiting of student-candidates by educational institutions (e.g. universities), a fundamental aspect of the recruiting process is to provide the student-candidate with a sense of student life, campus atmosphere, and/or available social and/or internship/career experience offerings from surrounding communities. Prior to the existence of the Internet, a student-candidate could only obtain an understanding of the campus and surrounding communities through anecdotes of current- or former-students, pictures, articles, or personal visits, which may be inconvenient and costly especially if the student-candidate does not reside relatively close to the university.

By using the Internet, one may acquire a sense of a cityscape through three-dimensional, 360-degree panoramic photographs available from, for example, IPIX® of San Ramon, Calif. As more powerful computers are allowing greater dynamic informational content to be viewed by an end-user, the increasing capability of graphic processors have enabled a generation of hardware that can create photo-realistic computer-generated environments that may be provided over the Internet at the consumer level. Accordingly, one may take a virtual tour of a cityscape at his/her own convenience from any location, such as, for example, one's residence, a computer terminal kiosk, or the like.

Accordingly, although a three-dimensional, 360-degree visualization of an environment may be made available to, for example, a student candidate by way of the Internet using conventional means, such three-dimensional, 360-degree visualizations of an environment, such as, for example, a virtual university campus, are typically focused on the presentation of exterior spaces (i.e. a facade view, side-wall view, rear-wall view, or bird's-eye, overhead view of a house, building, courtyard, or the like). Additionally, known 360-degree visualizations, such as, for example, in an aircraft flight simulator, are made available to assess a person's physical dexterity; however, such physical dexterity assessments of a person interacting with a virtual environment do not necessary provide feedback regarding a person's mental dexterity (e.g. I.Q., social skills, “the drive to succeed,” and the like).

Additionally, it is also known that alumni are often solicited by their alma mater for financial gifts, and in return, the university often offers recognition for the gifts such as by naming a campus building in recognition of the donor. The university's solicitation methodology for securing a financial gift can often be a critical aspect of the of the university-donor relationship. Typically, if, for example, a building is to be constructed in the donor's name, the donor would like to “see ahead of time what they are paying for.” Accordingly, an in person, on-site meeting is typically conducted with the potential donor being present with one or more educational institution representatives along with architectural planners, landscape architects, sculptors, or the like to provide the potential donor with a sense of what a building, landscaping, signage, statue, or the will look like by viewing hand-drawn or computer-generated hardcopies of a building, landscaping, signage, statue, or the like. Such in-person meetings require careful planning, time, and money.

As such, there is a need to provide a candidate, such as, for example, a student candidate, with the ability to navigate through a three-dimensional, 360-degree visualization of, for example, a virtual environment, such as, for example, a university campus, while remotely interacting with, for example, interior spaces of a building, other potential participants in the virtual environment, and/or other interactive features provided in the virtual environment, such as, for example intellectual puzzles/problems that may assist a recruiter in assessing a candidate's mental dexterity relating to their qualifications for various positions (i.e. acceptance into an academic institution, employment or the like). Additionally, there is a need to provide more information about a candidate to a recruiter other than by conventional means and methodologies associated with resumes, personal references, background checks, and the like. Additionally, there is a need to provide an efficient methodology for soliciting and securing financial gifts from potential donors to an educational institution or other donor worthy organizations.

### BRIEF DESCRIPTION OF THE DRAWINGS

The present disclosure will now be described, by way of example, with reference to the accompanying drawings, in which:

FIG. 1 is a representative view of a system and method for using virtual environments according to an embodiment;

FIG. 2 is a block diagram of the system and method for using virtual environments according to an embodiment;

FIG. 3 is a flow chart for operating the system and method from the candidate computer terminal side according to an embodiment;

FIG. 4 is a flow chart for operating the system and method from the recruiter computer terminal side according to an embodiment;

FIG. 5 is a flow chart illustrating a plurality of candidate interaction options of the system and method according to an embodiment;

FIG. 6 is a representative view of a system and method for using virtual environments according to an embodiment;

FIG. 7 is a block diagram of the system and method for using virtual environments according to an embodiment;

FIG. 8 is a flow chart for operating the system and method from the candidate computer terminal side according to an embodiment; and

FIGS. 9A and 9B represent a flow chart for operating the system and method according to an embodiment.

### DESCRIPTION OF THE PREFERRED EMBODIMENT

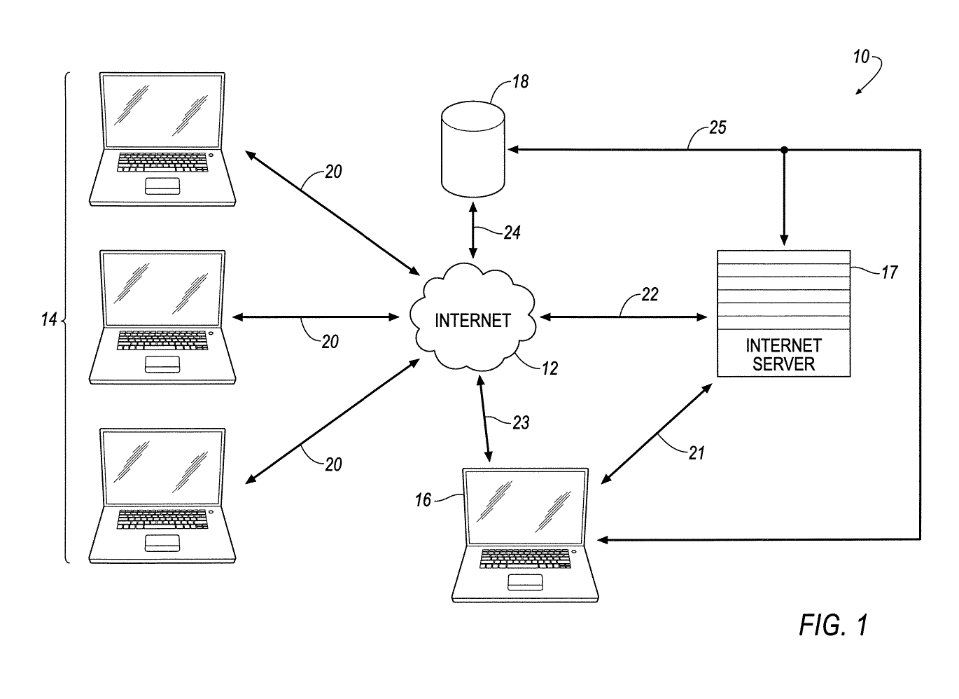

A system and method for using virtual environments is shown generally at 10 in FIG. 1 according to an embodiment. As illustrated, the Internet is generally represented at 12 in the form of a cloud, one or more candidates is/are shown generally at 14, and a recruiter is shown generally at 16. An internet server is generally shown at 17. Each candidate 14 and recruiter 16 is generally shown in the form of a computer workstation having a communication path 20, 23, respectively, with the Internet 12. According to an embodiment, the system and method 10 is particularly useful in facilitating a cohesive transmittal of information between the recruiter's organization and the potential candidates 14 by way of the Internet 12. According to an embodiment, the recruiter 16 may engage and evaluate the candidates 14 based on their interests, analytical capability, virtual social interactions (with other potential candidates 14 and/or the organization/recruiter 16), or any other test that can be envisioned (i.e. to assess the candidate's mental dexterity). According to an embodiment, the candidate's mental dexterity may be scored in the form of a quotient (i.e. the candidate 14 amasses points that are divided by a total number of potential points to create “a mental dexterity quotient”). Additionally, the candidate 14 may receive information about the organization associated with the recruiter 16 for the purpose of accepting/denying a potential invitation from the organization relating to an admission to the organization, a job offer, or the like.

The “institutional end” of this system 10 does not require the presence of a live person (represented by a recruiter 16). Although recruiter 16 can be a live person, it is also contemplated that “recruiter functions” discussed herein could be implemented algorithmically in software to create a virtual recruiter 16, or the like. Therefore, according to an embodiment, the institutional end of the system 10 may include a live person/recruiter 16 that operates a terminal, or, a virtual recruiter 16 implemented in software. According to an embodiment, automated software may be located, for example, at a server 17 to perform the function of operating a virtual recruiter 16, or, the virtual recruiter 16 may be implemented in a computer other than server 17, such as, for example, a computer workstation 16. Communication to/from a recruiter 16 and server 17 may be enabled over a communication path 21. Communication between the Internet 12 and server 17 may be enabled over a communication path 22. Communication between the server 17 and an operation module 18 may be enabled over a communication path 25.

In the case that the recruiter 16 is a live person operating the recruiter computer terminal, the recruiter 16 may include, for example, headhunters, human resource managers, admission officers, faculty, staff, leaders, managers, or the like. The candidates 14 may include, for example, potential students for a primary school, secondary school, university, or the like. Alternatively, the candidates 14 may include a(n) un/skilled worker seeking employment from a company, business, corporation, or the like. Alternatively, the candidates 14 may include one or more persons interested in joining a social group/club including, for example, a professional society, country club, or the like. As such, in the case that the recruiter 16 is a live person, the recruiter 16 may be part of/directly employed by, or, an agent of, for example, the primary school, secondary school, university, company, business, corporation, professional society, country club, or the like.

According to an embodiment, the system and method 10 may permit a recruiter 16 of an academic institution to ascertain a student candidate's mental dexterity (e.g. intelligence, I.Q., social maturity, and/or interest/appeal level). As such, the system and method 10 may increase the overall efficiency of the admissions process by facilitating a better understanding of the likelihood that a qualified student candidate 14 will accept an admission invitation. If desired, the academic institution may encourage/require that student candidates 14 participates in the system and method 10 as part of an admissions application process to supplement academic records, personal essays, and standardized test scores including, but not limited to Scholastic Aptitude Test (SAT) scores, American College Test (ACT) scores, Graduate Management Admission Test (GMAT) scores, Law School Admission Test (LSAT) scores, or the like. The system and method 10 may enable a recruiter 16 to quickly and efficiently sort the eager, academically well-qualified student candidates 14 from less eager and/or less qualified student candidates 14.

Regarding traditional student admission application procedures, it is known that a student candidate 14 may be inclined to accept an admission invitation from his/her 1^{st} choice institution while also applying to 2^{nd}, 3^{rd}, or 4^{th} choice institutions. The application to the 2^{nd}, 3^{rd}, or 4^{th} choice institutions may be executed by the student candidate 14 for his/her own self-assessment, or, alternatively, as insurance in the event that the 1^{st} choice institution does not extend an admission invitation to the candidate 14. Accordingly, the conventional admission application to 2^{nd}, 3^{rd}, or 4^{th} choice institutions may be made solely based upon name/reputation and/or reviews of the 2^{nd}, 3^{rd}, or 4^{th} choice institutions without the candidate 14 ever seriously considering a potential admission invitation from 2^{nd}, 3^{rd}, or 4^{th} choice institutions, should one be extended. As such, the system and method 10 may also serve as an admission application deterrent for less eager/serious student candidates 14 who are less likely to apply to a 2^{nd}, 3^{rd}, or 4^{th} choice institution that utilizes/requires the use of the system and method 10 if the student candidate's interest in attending the 2^{nd}, 3^{rd}, or 4^{th} choice institution is not relatively serious. A student candidate 14 that is interested in a particular academic institution and also participates in the system and method 10 would have an advantage over less eager/serious/qualified student candidates 14 who practice the conventional admission application method/process by providing the academic institution with only an application fee, academic resume, essay, SAT score, ACT score, GMAT score, LSAT score, or the like.

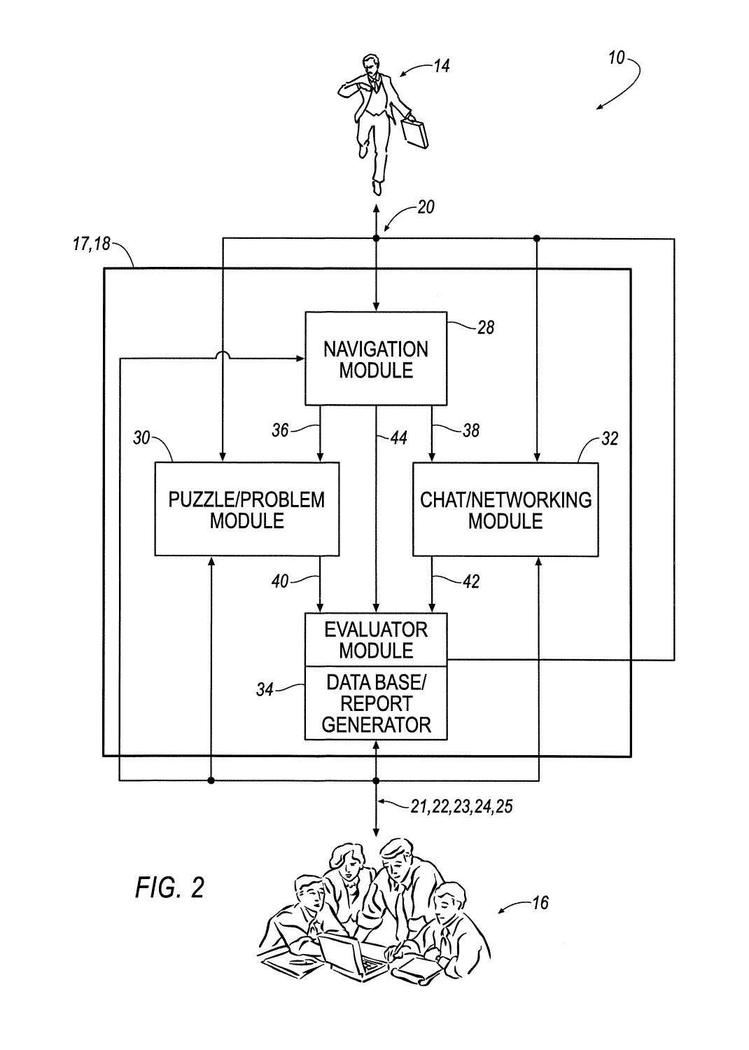

Referring to FIGS. 1 and 2, an operation module of the system and method 10 is shown generally at 18. The operation module 18 is hosted by, or, hosted on behalf of the recruiter 16. Although the operation module 18 is shown remotely with respect to the location of the recruiter 16 in FIG. 1, it will be appreciated that the operation module 18 may be located proximate, integral, and/or networked with the recruiter's computer workstation 16. Accordingly, if the operation module 18 is remotely located, as illustrated in FIG. 1, the operation module 18 may communicate with the Internet 12 over a communication path 24 and/or with the recruiter 16 over a communication path 25; otherwise, the operation module 18 may communicate over the Internet 12 over the communication path 23. It will be appreciated that that operation module 18 may be remotely located, or, located proximate the Internet server 17. If located remotely away from the Internet server 17 as shown in FIG. 1, the operation module 18 may communicate with the Internet server 17 over communication paths 22, 25. In addition to one or more computer workstations in FIG. 1, the candidate 14 and/or recruiter 16 may also utilize sensory stimulating technologies including, but not limited to, a virtual reality head-mounted display, force feedback actuators, sound devices, olfactory stimulating devices, or the like.

Additionally, the system and method 10 may include one or more telephones, IP telephones, microphones, or the like so that the candidate 14 and/or recruiter 16 may communicate verbally over the Internet 12 using well-known voice over IP (VoIP) technologies. Accordingly, such equipment may be used as a primary component to enable communications between one or more candidates 14, recruiters 16, or the like. Alternatively such equipment may be used to supplement the keyboard to enable voice and text communications between one or more candidates 14, recruiters 16, or the like.

In an application, according to an embodiment, the operation module 18 integrates system-level technologies to produce a compelling mechanism that remotely interfaces with, informs, guides, entertains, and/or evaluates a candidate 14 over the Internet 12. Referring to FIG. 2, the system-level technologies may include, but are not limited to, a navigation module 28, a puzzle/problem module 30, a chat/networking module 32, and an evaluator module 34. As illustrated, the candidate 14 has bidirectional communication with each of the navigation, puzzle/problem, and chat/networking modules 28, 30, 32 over the communication channel 20. The recruiter 16, may similarly have bi-directional communication with each of the navigation and chat/networking modules 28, 32. If desired, the recruiter 16 may permit feedback to the candidate 14 from the evaluator module 34 over the communication channel 20.

The navigation module 28 may include a real-time graphics engine, a virtual reality engine, an immersive graphics medium, a physics engine, or the like. ‘Navigation,’ through the interactive graphical environment, can be adapted to encompass the range of traditional input devices (i.e., a keyboard/mouse/joystick), as well as imminent implementations of gyroscopic motion-tracking devices, or, alternatively, advanced eyeball tracking devices or the like.

The puzzle/problem module 30 may include application specific software authored for/by the organization/recruiter 16 that includes questions pertaining to, or, about the organization. It will be appreciated that the puzzles/problems may be customized based on case studies, logic problems, memory tests, trivia questions, strategy games, or the like. ‘Puzzle/Problem Solving’ is designed to captivate and evaluate the candidate 14. The puzzles/problems are designed to pose an intellectual challenge while providing sensory clues to the candidate 14.

The chat/networking module 32 may include an online networked utility. ‘Networking’ will allow communication among various candidates 14 within the interactive graphical environment. The chat/networking module 32 may be implemented as a client/server system to engage many candidates 14 simultaneously. The client/server system permits communication between the local client hardware and the centralized server that receives a report at the end of the candidate's virtual environment experience.

The evaluator module 34 may include a database and report generation utility that can be standardized to feed Customer Relationship Management tools and the like. An embedded evaluator is included in the evaluator module 34 and may selectively choose to provide feedback to the candidate 14, based upon the recruiter's pre- or post-defined criteria. The evaluation performed by the evaluator module 34 forms the core of the recruiting function and serves to test, monitor, and evaluate the candidate 14 during his/her interaction with the program. The evaluation may be a summary of the candidate's experience and can be provided in a customizable format. The format can be designed to feed any Customer Relationship Management Tools or Data Mining Utilities to assist in deciphering or correlating information. The evaluation may contain a score and any other additional data that can be used by, for example, admissions staff in an academic institution as a qualifying criterion. Feedback may be provided during and/or after the virtual environment experience to help guide candidates 14 and/or recruiters 16 through admissions process.

During the course of the navigation of the virtual environment, the navigation module 28 may invoke the puzzle/problem module 30 and/or chat/networking module 32 as indicated at communication lines 36, 38. To invoke the puzzle/problem module 30, for example, the candidate 14 may navigate to a visible/invisible target in the virtual environment, and, upon arriving at the target, a puzzle/problem may appear or be opened for the candidate 14 to solve, and, the candidate's answer may be scrutinized. To invoke the chat/networking module 32, for example, the candidate 14 may navigate to a virtual candidate 14 and/or recruiter 16, which may appear as a virtual person, and, upon arriving at the location of the virtual person, a chat window may appear for selection. Alternatively, the candidate 14 may click on a graphical “chat button” appearing in the computer terminal monitor to request/initiate a chat with other candidates 14 and/or a recruiter 16 that are available and currently navigating the virtual environment. Puzzle/problem scores, chat/networking logs, and/or navigation logs may be provided to the evaluator module 34 over communication lines 40, 42, 44, respectively. The tallied scores and log reports of the candidate 14 can be saved locally in, or, remotely from the operation module 18 for later analysis by the recruiter 16.

As indicated, the navigation module 28 is employed to permit the candidate 14 to explore interactive graphics provided by the organization/recruiter 16 that may be in the form of a three-dimensional, 360-degree virtual environment (i.e. virtual reality imaging). According to an embodiment, the virtual environment may replicate existing facilities on a university campus including dormitories, classroom buildings, student activity buildings, libraries, social halls, bookstores, stadiums, gymnasiums, offices relating to admissions/registrars/professors/academic advisor, deans, or the like. The generation of the interactive graphics to the candidate 14 can be achieved through the real-time graphics engine, virtual reality engine, or any desirable immersive graphical mechanism. As such, a networked exploration of a virtual space is provided where multiple candidates 14 can interact by means of a seamlessly integrated interface provided by the operation module 18. According to an embodiment, one or more candidates 14 may elect to have a virtual tour guide, virtual admissions representative, or virtual faculty member lead/participate in a virtual exploration in addition to answering any questions that the candidate 14 may have.

In addition to the exploratory interactions that a candidate 14 may take advantage of by using the system and method 10, the recruiter 16 may harvest additional information about the candidate 14 for later evaluation during admission selection process. As the candidate 14 navigates the virtual environment, the puzzle/problem module 30 and chat/networking module 32 may be invoked, as describe above, or, at any desirable time by default programming, or, by the recruiter 16.

For example, if a candidate 14 is interested in attending the university's law school, the candidate 14 may navigate the virtual campus to the location of the law school, and, upon entering the grounds of the virtual law school, the puzzle/problem module 30 may be invoked and the candidate 14 may be presented with facts or statistics about the law school that may be un/familiar to the candidate 14. As such, the candidate 14 may be prompted with the following information: “Welcome to University Law School. The first dean of the law school was Joseph John Doe in the year 1858.” As the candidate 14 continues to navigate the virtual law school campus, the candidate 14 may be engaged with additional facts relating to the law school, such as, for example, current staff and what their specialties are, and, at a time later, be asked questions relating to facts that may or may not have been presented, such as: “Who was the first dean of the law school?,” “In what year was the first dean installed?,” or “Who currently instructs a course on Antitrust Law?” If questions are answered in/correctly, the candidate 14 may increase/decrease a score or number of points that may have an overall bearing on a final score/number of points accumulated during the virtual environment experience.

As the puzzle/problem module 30 manages and delivers information to the candidate 14, the chat/networking module 32 may retain a log of conversations that the candidate 14 holds with other candidates, agents of the recruiters, or the recruiters 16 themselves to determine a sense of the candidate's responses, approach, and strategy in articulating their thoughts. Upon exhausting the puzzles/problems and exiting the virtual environment, the embedded logic of the evaluator module 34 assesses the candidate's intellect by providing a score, which may be weighed by the speed and accuracy that puzzles/problems were solved. Additionally, the log of chats held by the candidate 14 may be stored for later review by the recruiter 16. If desired, the log of chats may be scored in view of the candidate's use of proper grammar and/or spelling. The candidate 14 may then be assigned a “virtual environment rating,” which may be available in a standardized score/rating format as a supplement to an academic institution's admissions criteria by the evaluator module 34 based on his/her interaction with the customized puzzles/problems and/or chat log.

Additional information about the candidate 14 may be obtained by using the embedded evaluator to monitor the candidate's navigational responses instigated by visual triggers incorporated into the graphical user interface. For example, the embedded evaluator may observe the amount of time that users spends looking at certain types of virtual bulletin boards as an indication of the candidate's interests, their inclination towards an art, or the candidate's proclivity towards aspects of the campus facilities. Further information may be ascertained from the interactions that take place among multiple candidates over an online network. Additionally, the embedded evaluator may look for key words used during networked interactions by the candidate 14 to gain a sense of his/her personality traits, tastes, characteristics, word skills, and the like. The embedded evaluator may, in response to a key/flagged-word evaluation, prompt the candidate 14 by offering navigation suggestions, in the form of, for example, pop-up windows or pop-up navigational arrows, that are triggered by the detection of the key/flagged words from a chat log.

For example, if the student chats with other candidates 14 about fraternities/sororities and spends time looking at a virtual flyer placed on a bulletin board in an academic building for an upcoming event at a fraternity/sorority house, navigation arrows may be provided to direct the candidate 14 to the location of the fraternity/sorority house. If desired, information about the candidate's interests in the fraternity/sorority event may trigger the evaluator module 34 to provide the fraternity/sorority with a notice that the candidate 14 is possibly interested in becoming new member. Upon gaining this insight, the fraternity/sorority may contact the candidate 14 during rush week regarding rush week events should the candidate 14 be invited to and join the university. Additionally, the candidate's profile may be flagged to provide additional information about the fraternity/sorority by way of any desirable means, such as email, conventional hand delivery mail, or the like.

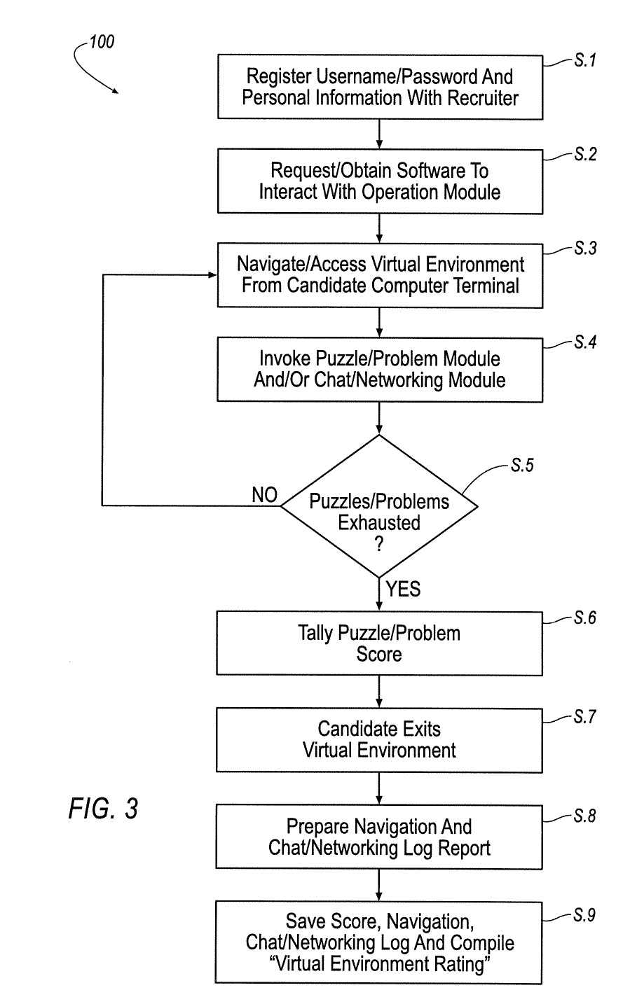

Referring now to FIG. 3, a flow chart 100 for operating the system and method 10 from the candidate computer terminal side is shown according to an embodiment. First, at step S.1, the candidate 14 registers a username/password and personal information with a recruiter 16 and/or internet server 17 on the institutional end of the system 10. The personal information may include the name, address, telephone, email address, social security number, resume, academic records, personal essays, a SAT score, an ACT score, a GMAT score, a LSAT score, or the like. The registration may take place, for example, by way of an electronic communication over the Internet 12, or, by way of, a paper-based system via traditional mail service. Then, at step S.2, software that enables interaction with the operation module 18 is requested/obtained by way of, for example, an electronic download over the Internet 12. Alternatively, the software may be acquired on a CD-ROM from the organization/recruiter 16 and installed on the candidate's computer terminal.

At step S.3, the candidate 14 executes the software for interacting with the operation module 18 and navigates the virtual environment as described above. At step S.4, during the navigation of the virtual environment, the puzzle/problem module 30 and/or the chat/networking module 32 may be invoked as described above. Then, at step S.5, the operation module 18 will detect if and when the puzzles/problems made available to the candidate 14 have been exhausted. Upon exhausting the puzzles/problems, the operational module 18 will tally a score of the un/solved puzzles/problems at step S.6.

At step S.7, the candidate 14 may, at any time, manually exit the virtual environment; alternatively, upon exhausting the puzzles/problems, the operation module 18 may automatically cause the candidate 14 to exit the virtual environment, signaling the end of the program. According to another embodiment, the candidate 14 may automatically exit the virtual environment if access time to the virtual environment is set and limited, for example, by the organization/recruiter 16 such that the candidate 14 is offered a limited amount of time to locate and solve puzzles/problems in a similar fashion associated with standardized tests. At step S.8, the operation module 18 may prepare a chat/networking log report, and then, at step S.9, the score of the puzzles/problems, navigation and chat/networking log is saved and compiled by the operation module 18 as a “virtual environment rating” for later processing and/or analysis by the recruiter 16.

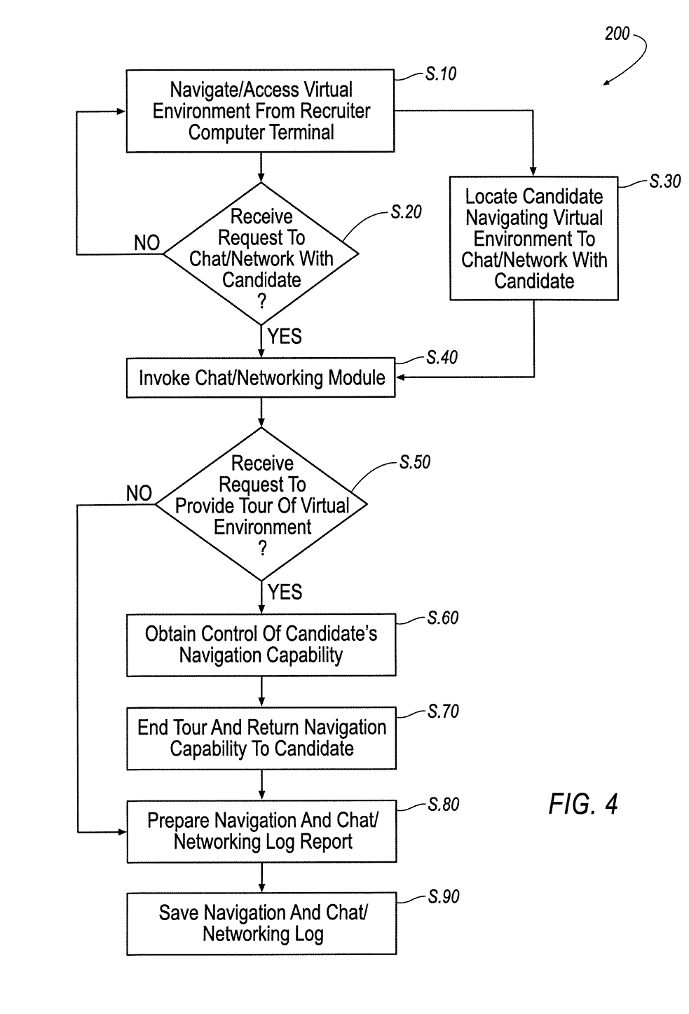

Referring now to FIG. 4, a flow chart 200 for operating the system and method 10 from the recruiter computer terminal side is shown according to an embodiment. First, at step S.10, a live recruiter 16 (i.e. a person) or a virtual recruiter 16 (i.e., an automated program) navigates/accesses the virtual environment, with, for example, an assigned username/password. Then, at step S.20, the recruiter 16 may receive a request to chat/network with a candidate 14; alternatively, the recruiter 16 may locate a candidate 14 in the virtual environment at step S.30 for unsolicited chatting/networking. Upon engaging the candidate 14 at either step S.20 or S.30, the chat/networking module 32 is invoked at step S.40 from the recruiter computer terminal side.

At step S.50, the recruiter 16 may receive a request from the candidate 14 for a tour of the virtual environment. If a tour is requested, the recruiter 16 may obtain control of the candidate's navigation capabilities at step S.60, conversely, if no request for a tour is placed, the flow chart is advanced to step S.80. Upon completing the tour, should one be requested, the recruiter 16 may return navigation controls back to the candidate 14 at step S.70 for independent exploration of the virtual environment. Then, at step S.80, the recruiter 16 may request/initiate a navigation and chat/networking log report by the operation module 18, which may include notes prepared by the recruiter 16 of his/her impression of the candidate 14. At step S.90, the navigation and chat/networking report, which may or may not include the recruiter's notes, are saved by the operation module 18.

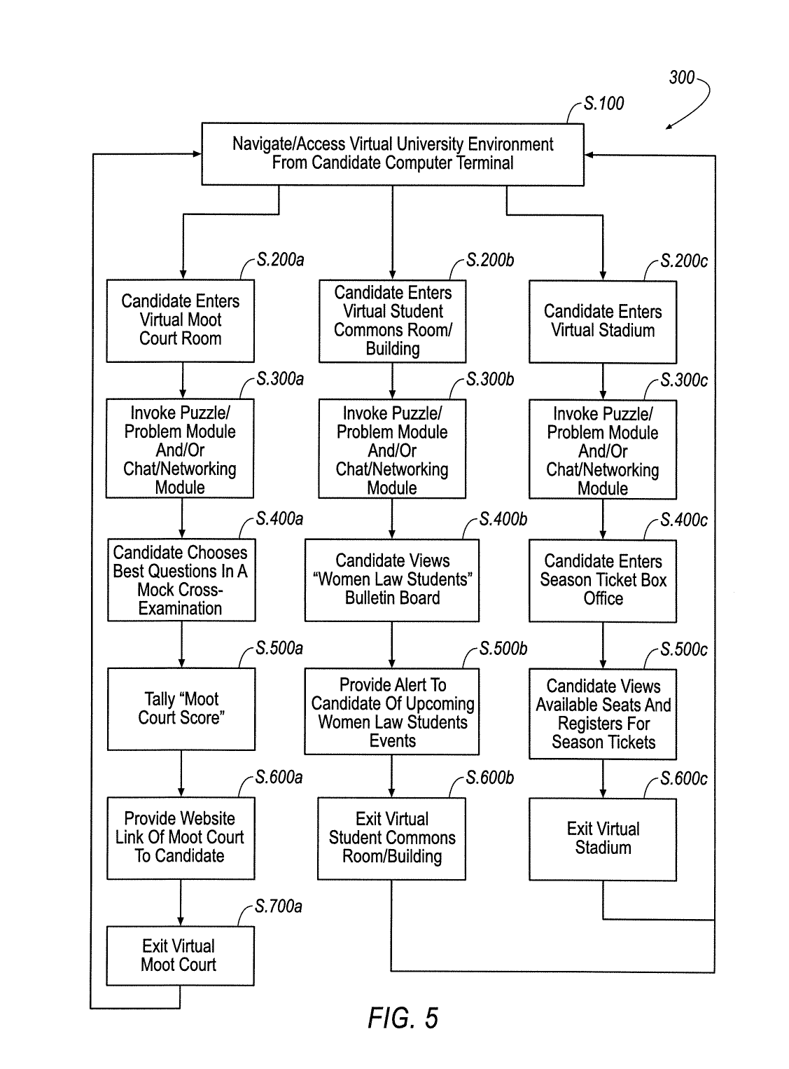

Referring now to FIG. 5, a flow chart 300 illustrating a plurality of interaction options of the system and method 10 from the candidate computer terminal side is shown according to an embodiment. Although the flow chart 300 illustrates three general option branches starting, respectively, at steps S.200a, S.200b and S.200c, it will be appreciated that the disclosure is not limited to the three illustrated examples and that any desirable option may be programmed, as determined by the organization.

First, a student candidate 14 may access a virtual reality law school campus environment as described above in steps S.1-S.3. Then, at step S.200a, the student candidate 14 may navigate to, and discover, a virtual moot court room. Once inside the virtual moot court room, the puzzle/problem module 30 and/or chat networking module 32 may be invoked at step S.300a so that the candidate 14 may participate in a simulated mock cross-examination at step S.400a in which the candidate 14 may choose, for example, a “best question” from a plurality of questions that are expressed in, for example, a multiple-choice-style format. Upon completing the simulated mock cross-examination, a “moot court score” may be tallied at step S.500a. Then, at step S.600a, the operation module 18 may provide additional information regarding the moot court program at the law school, such as, for example, a website link. At step S.700a, the candidate 14 exits the virtual moot court and returns to the virtual reality law school campus.

At step S.200b, the candidate 14 may navigate to, and discover a virtual student common room/building. Once inside the virtual student common room/building, the puzzle/problem module 30 and/or chat networking module 32 may be invoked at step S.300b. At step S.400b, the candidate 14 may navigate to and discover a “Woman Law Student” bulletin board. After viewing the “Woman Law Student” bulletin board for a predetermined period of time, the operation module 18 may provide an alert, for example, in the form of a pop-up window, emails, or the like regarding upcoming Woman Law Students events at step S.500b. At step S.600b, the candidate 14 exits the virtual student common room/building and returns to the virtual reality law school campus.

At step S.200c, the candidate 14 may navigate to, and discover a virtual stadium. Once on the grounds of the virtual stadium, the puzzle/problem module 30 and/or chat networking module 32 may be invoked at step S.300c. Then, at step S.400c, the candidate 14 may enter the stadium's virtual season ticket box office. At step S.500c the candidate 14 may manually, or, as described above in steps S.50-S.70, take a guided tour of the virtual stadium with a virtual box office agent to pick out the best available seat for an upcoming football season. If desired, the candidate 14 may register for season tickets with the virtual box office agent. At step S.600c, the candidate 14 may return to the virtual reality law school campus.

Although the above-described examples are related to educating a student candidate 14 that is interested in learning more about a university, and assessing a student candidate 14 by an agent of the university, it will be appreciated that the system and method 10 may be applied to assess any candidate 14 for other types of organizations or institutions. As an example, a recruiter 16 of an electrical engineering firm may pose electrical circuit problems to a candidate 14 to determine the candidate's abilities prior to conducting a more detailed in-person interview. If the candidate 14 is interested in the position, and must relocate, the recruiter 16 may give the candidate 14 a virtual tour of the local and/or regional area. According to an embodiment, the operation module 18 may include or interface/interact with virtual reality real estate databases to provide the recruiter 16 and/or candidate 14 with virtual tours, availability, and pricing indexes of homes, apartments, condominiums, and the like that are available for sale or rent to assist a potential job candidate 14 that may need to relocate should a job offer be extended. According to another embodiment, the recruiter 16 may be a manager of a country club and offer a potential candidate member 14 a tour of a golf course, tennis courts, dining facilities, swimming pools, and the like. If the candidate member 14 is interested in joining, a “virtual meet and greet” of current members may be conducted prior to joining the club.

As such, it will be appreciated that system and method 10 is useful in a number of applications for the benefit of providing information about an organization to a candidate 14 while also assessing the many qualities and capabilities of the candidate 14. Candidates 14 and organizations/recruiters 16 alike may mutually benefit from the capabilities of the system and method 10 to determine if a mutually beneficial relationship between the candidate 14 and the organization is desirable.

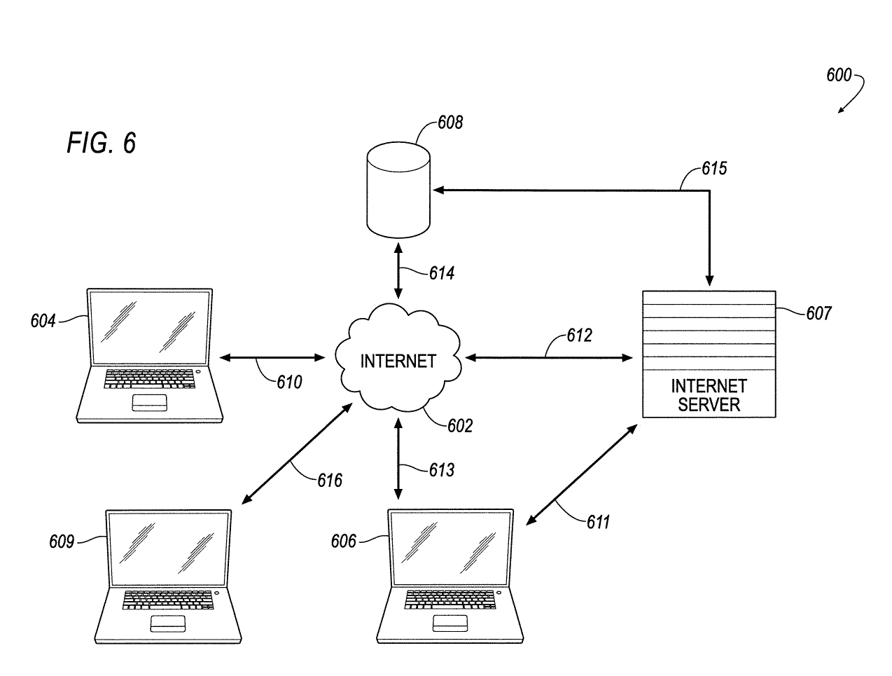

A system and method for using virtual environments is shown generally at 600 in FIG. 6 according to an embodiment. The system and method 600 is generally related to the utilization of interactive graphics for soliciting and securing financial gifts from potential donors to an organization. According to an embodiment, the organization may be, for example, an educational institution, such as, for example, a university or any other donor worthy institution.

As illustrated, the Internet is generally represented at 602 in the form of a cloud, one or more potential donors is generally represented at 604, an educational institution representative, such as, for example, an alumni-relations officer, is shown generally at 606, and a financial institution representative is shown generally at 609. Each potential donor 604, educational institution representative 606, and financial institution representative 609 is generally shown in the form of a computer workstation having a communication path 610-616 with the Internet 602. Although the term “education institution representative” is used in relation to reference numeral 606, it will be appreciated that the representative 606 may also be referred to as a solicitor, or the like; as such, reference numeral 606 is not limited to an educational institution, an educational institution representation, agent, or the like, and may, for example, represent a donation/grant solicitor, for any organization, institution, or the like, such as, for example, a charity, religious institution (i.e. a church, synagogue, mosque), non-profit organization, or the like.

According to an embodiment, the system and method 600 is particularly useful in facilitating a cohesive transmittal of information between a potential donor 604, educational institution representative 606, and financial institution representative 609 by way of the Internet 602. According to an embodiment, the potential donor 604 and/or educational institution representative 606 may access, modify, and/or collaboratively edit a feature in the virtual environment for the purpose of illustrating a view of a building, statue, signage, or the like relating to the potential donor's likeness, namesake, organization, or the like. According to an embodiment, the educational institution representative 606 may take the potential donor 604 on a virtual tour of the virtual environment via the Internet 602 while modifying/editing a feature in the virtual environment for the purpose of illustrating a un/modified view of a building, statue, nameplate, or the like relating to the potential donor's likeness, namesake, organization, or the like. According to an embodiment, the potential donor 604 and/or educational institution representative 606 may interact with one or more financial institution representatives 609 to facilitate a financial transaction, such as, for example, a grant or donation, from the potential donor 604 to the educational institution 606.

The “educational institutional end” of this system 600 does not require the presence of a live person (represented by an educational institution representative 606). Although educational institution representative 606 can be a live person, it is also contemplated that the educational institution representative functions discussed herein could be implemented algorithmically in software to create a virtual educational institution representative 606, or the like. Therefore, according to an embodiment, the institutional end of the system 600 may include a live person/educational institution representative 606 that operates a terminal or a virtual educational institution representative 606 implemented in software. According to an embodiment, automated software may be located at a server 607 to perform the function of operating a virtual educational institution representative 606 or it may be implemented in a computer other than server 607. Communication to/from a educational institution representative 606 and server 607 may be enabled over a communication path 611-615.

In the case that the educational institution representative 606 is a live person operating a computer terminal, the educational institution representative 606 may include, for example, a university's chairman, one or more directors from a board, a business development representative, an alumni relations officer, or the like. The potential donors 604 may include, for example, an alumnus, a community leader, a business organization representative, a benefactor, or the like.

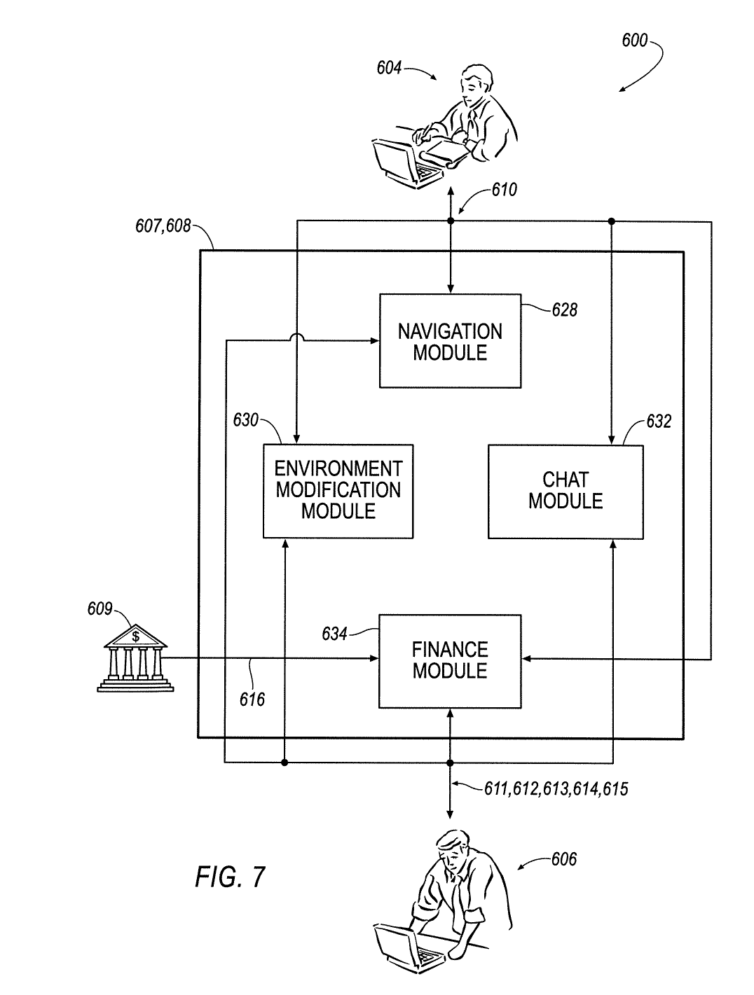

Referring to FIGS. 6 and 7, an operation module of the system and method 600 is shown generally at 608. The operation module 608 is hosted by, or, hosted on behalf of the educational institution representative 606. Although the operation module 608 is shown remotely with respect to the location of the educational institution representative 606 in FIG. 6, it will be appreciated that the operation module 608 may be located proximate, integral, and/or networked with the educational institution representative's computer workstation 606. In addition to the computer workstation in FIG. 6, the potential donor 604 and/or educational institution representative 606 may also utilize sensory stimulating technologies including, but not limited to, a virtual reality head-mounted display, force feedback actuators, sound devices, olfactory stimulating devices, or the like.

Additionally, the system and method 600 may include one or more telephones, IP telephones, microphones, or the like so that the potential donor 604 and/or educational institution representative 606 may communicate verbally over the Internet 602 using well-known voice over IP (VoIP) technologies. Accordingly, such equipment may be used as a primary component to enable communications between a potential donor 604, institutional representatives 606, or the like. Alternatively such equipment may be used to supplement the keyboard to enable voice and text communications between one or more potential donors 604, institutional representatives 606, or the like.

Referring to FIG. 7, the system-level technologies may include, but are not limited to, a navigation module 628, an environment modification module 630, a chat module 632, and a finance module 634. As illustrated, the potential donor 604 has bi-directional communication with each of the navigation, environment modification, chat, and finance modules 628-634 over the communication channel 610. The educational institution representative 606, may similarly, have bi-directional communication with each of the navigation, environment modification, chat, and finance modules 628-634.

The navigation and environment modification modules 628, 630 may include a real-time graphics engine, a virtual reality engine, an immersive graphics medium, a physics engine, or the like. The environment modification module 630 may include application specific software that permits the potential donor 604 and/or educational institution representative 606 to alter, change, modify, or otherwise edit buildings, landscaping, signage, or the like in the virtual environment. ‘Navigation’ and ‘Modification’ in the interactive graphical environment, can be adapted to encompass the range of traditional input devices (i.e., a keyboard/mouse/joystick), as well as imminent implementations of gyroscopic motion-tracking devices, or, alternatively, advanced eyeball tracking devices or the like.

The chat module 632 may include an online networked utility. ‘Chatting’ will allow communication between potential donors 604, educational institution representatives 606, and financial institution representatives 606 within the interactive graphical environment. The chat module 632 may be implemented as a client/server system to engage many potential donors 604 simultaneously. The finance module 634 may include a database and report generation utility that can be standardized to feed one or more financial databases associated with, for example, the donor's financial institution 609 over a communication path 616 and the education institution's financial institution 609.

To invoke the chat module 632, for example, the potential donor 604 may navigate, in the virtual environment, to an educational institution representative 606, which may appear as a virtual person, and, upon arriving at the location of the virtual person, a chat window may appear for selection. Alternatively, the potential donor 604 may click on a graphical “chat button” appearing in the computer terminal monitor to request/initiate a chat with an educational institution representative 606 that is available and currently navigating the virtual environment.

As indicated, the navigation module 628 is employed to permit the potential donor 604 to explore interactive graphics provided by the organization/educational institution representative 606 that may be in the form of a three-dimensional, 360-degree virtual environment (i.e. virtual reality imaging). According to an embodiment, the virtual environment may replicate existing facilities on a university campus including dormitories, classroom buildings, student activity buildings, libraries, social halls, bookstores, stadiums, gymnasiums, offices relating to admissions/registrars/professors/academic advisor, deans, or the like.

The generation of the interactive graphics to the potential donor 604 can be achieved through the real-time graphics engine, virtual reality engine, or any desirable immersive graphical mechanism. As such, a networked exploration of a virtual space is provided where a potential donors 604 can interact by means of a seamlessly integrated interface provided by the operation module 608.

According to an embodiment, one or more potential donors 604 may elect to have a virtual tour guide, virtual admissions representative, or virtual alumni relations officer lead/participate in a virtual exploration in addition to answering any questions that the potential donor 604 may have. In addition to the exploratory interactions that a potential donor 604 may take advantage of by using the system and method 600, the environment modification module 630 and chat module 632 may automatically save the “modification and chat session” between the potential donor 604 and educational institution representative 606 so that exact changes to the virtual environment and likings of the potential donor 604 may be passed on for later use by a professional, such as, for example, an architect, landscape designer, sculptor, or the like, that may execute design plans in the real world that is being simulated in the virtual environment. Alternatively, if desired, the passing-on of the modification and chat session may be eliminated, and, a professional, such as, for example, an architect, landscape designer, sculptor, or the like, may participate in real time during the virtual tour, chat, or the like by way of a computer terminal workstation that interacts with the system and method 600 over the Internet 602 with the potential donor 602 and/or educational institution representative 606.

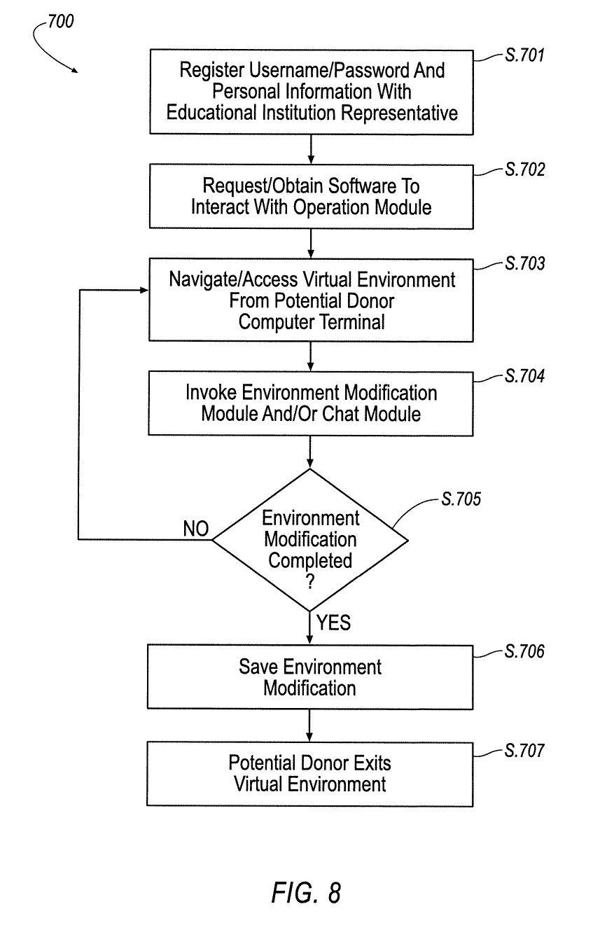

Referring now to FIG. 8, a flow chart 700 for operating the system and method 600 from the potential donor computer terminal side is shown according to an embodiment. First, at step S.701, the potential donor 604 registers a username/password and personal information with an educational institution representative 606 and/or internet server 607 on the institutional end of the system 600. The personal information may include the name, address, telephone, email address, a donor's financial institution name, a donor's financial institution account number, or the like. The registration may take place, for example, by way of an electronic communication over the Internet 602, or, by way of, a paper-based system via traditional mail service. Then, at step S.702, software that enables interaction with the operation module 608 is requested/obtained by way of, for example, an electronic download over the Internet 602. Alternatively, the software may be acquired on a CD-ROM from the organization/educational institution representative 606 and installed on the potential donor's computer terminal.

At step S.703, the potential donor 604 executes the software for interacting with the operation module 608 and navigates the virtual environment as described above. At step S.704, during the navigation of the virtual environment, the environment modification module 630 and/or the chat module 632 may be invoked as described above. Then, at step S.705, the operation module 608 will detect if and when the potential donor has indicated that a modification to the virtual environment is completed (e.g., by initiating a “save changes” feature, in, for example step S.706). At step S.707, the potential donor 604 may, at any time, manually exit the virtual environment, signaling the end of the program.

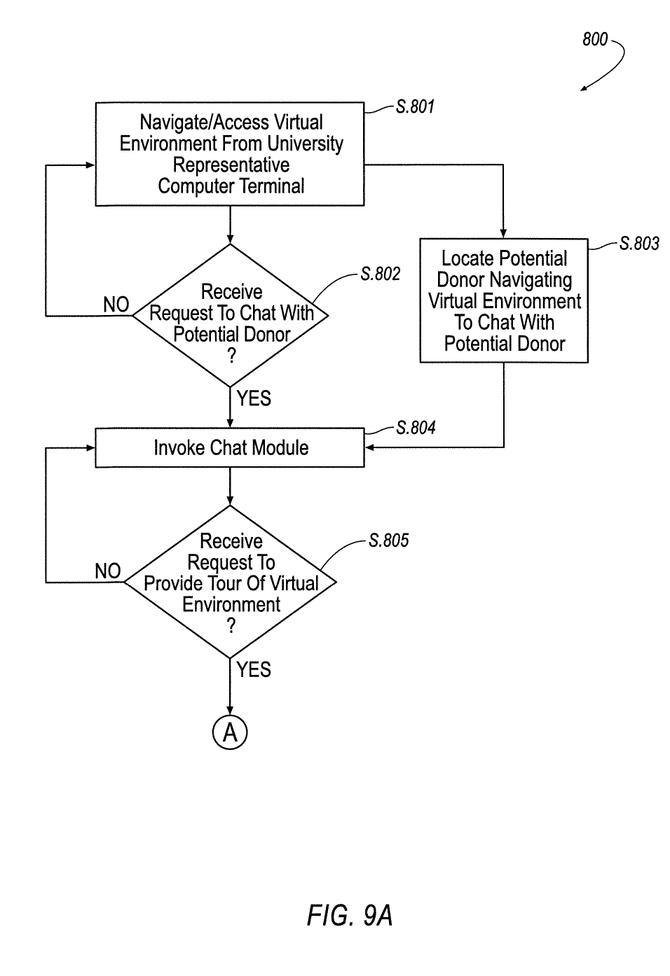

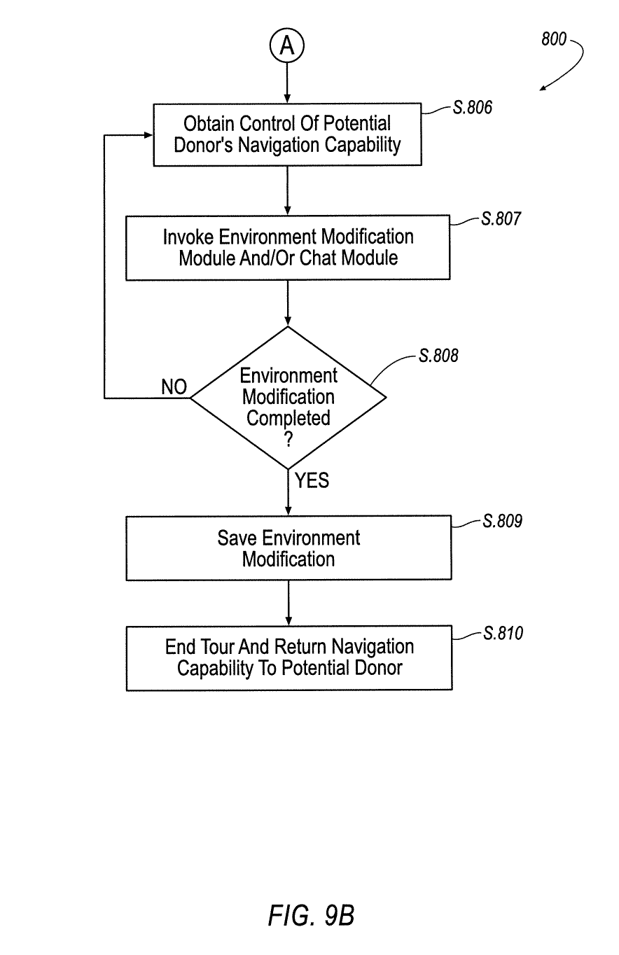

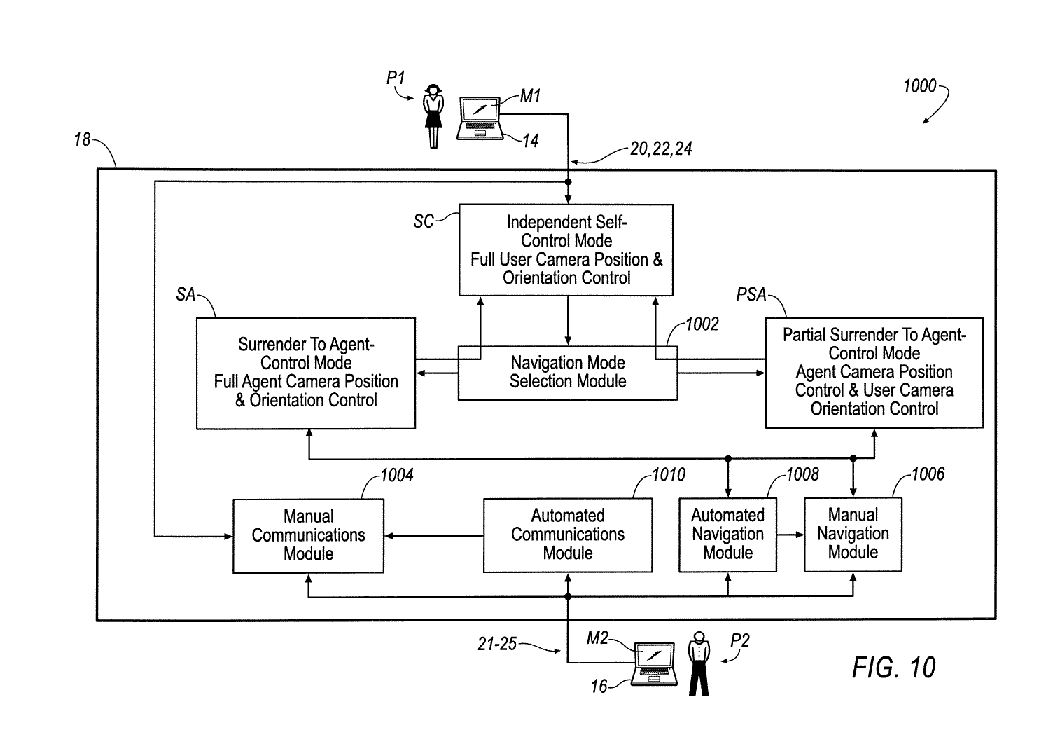

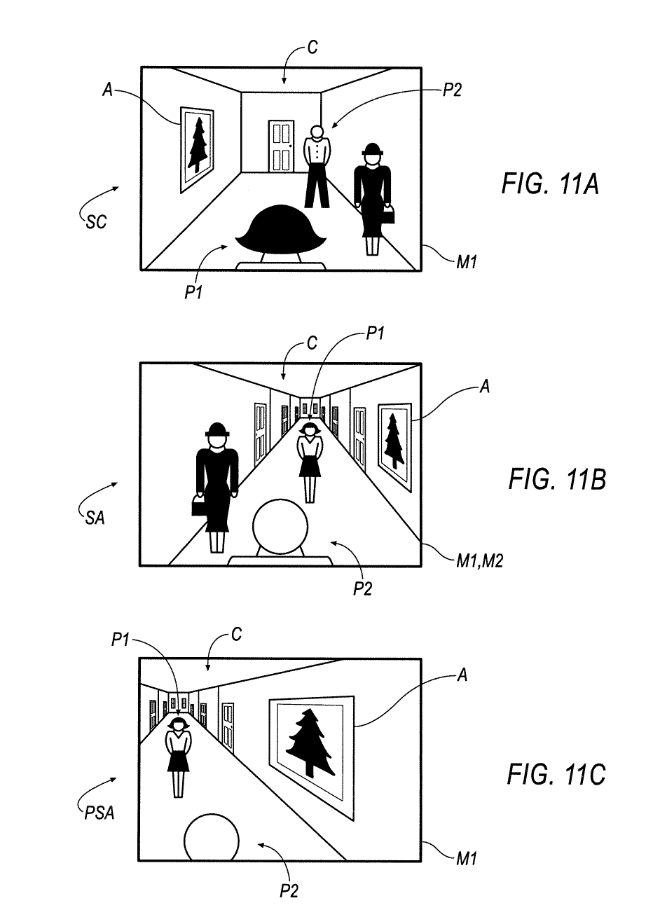

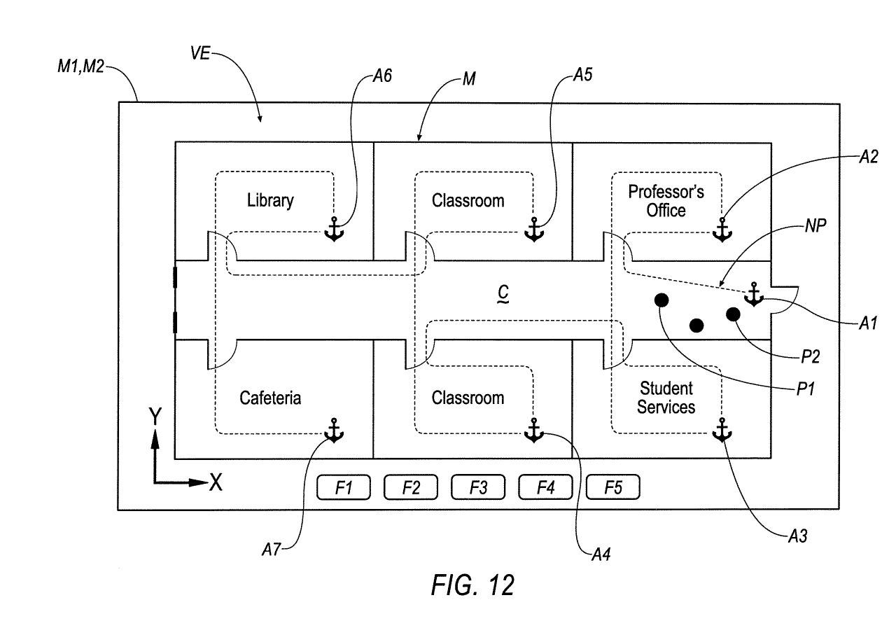

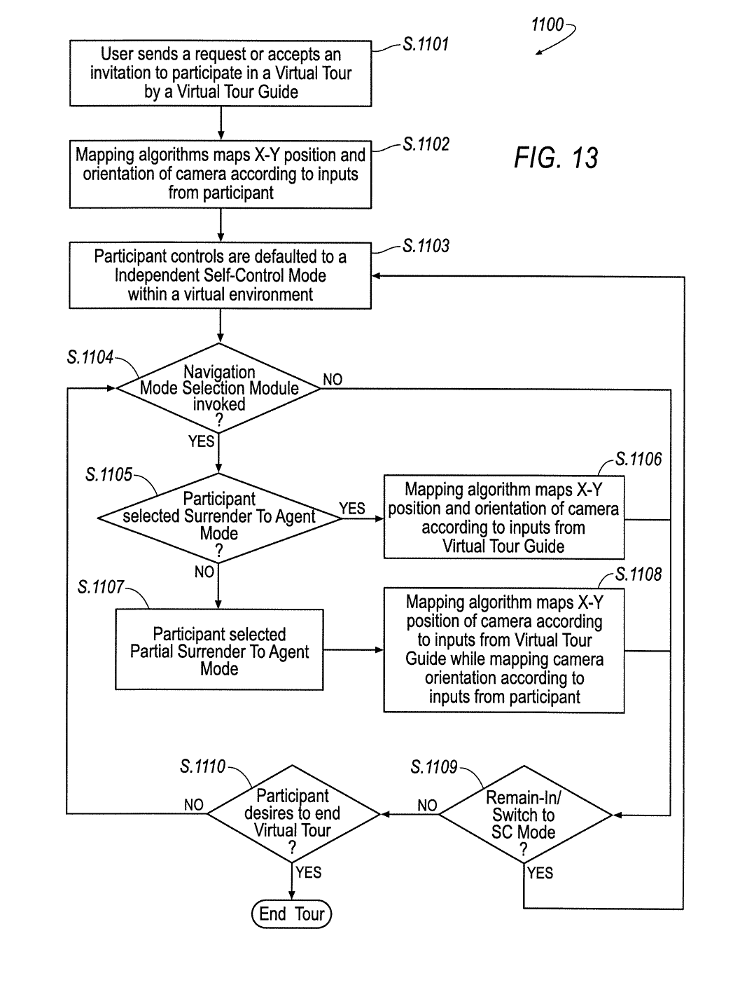

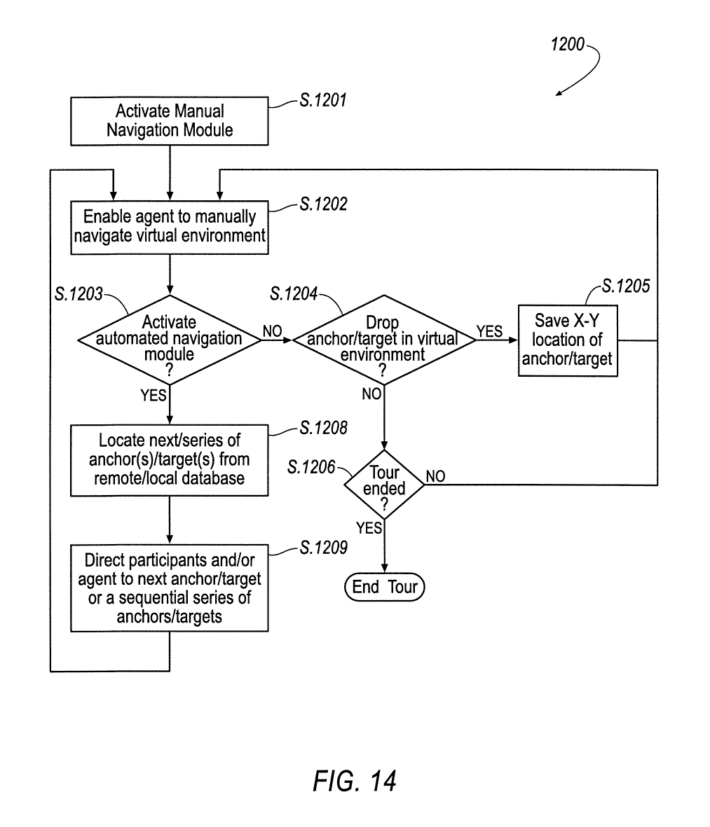

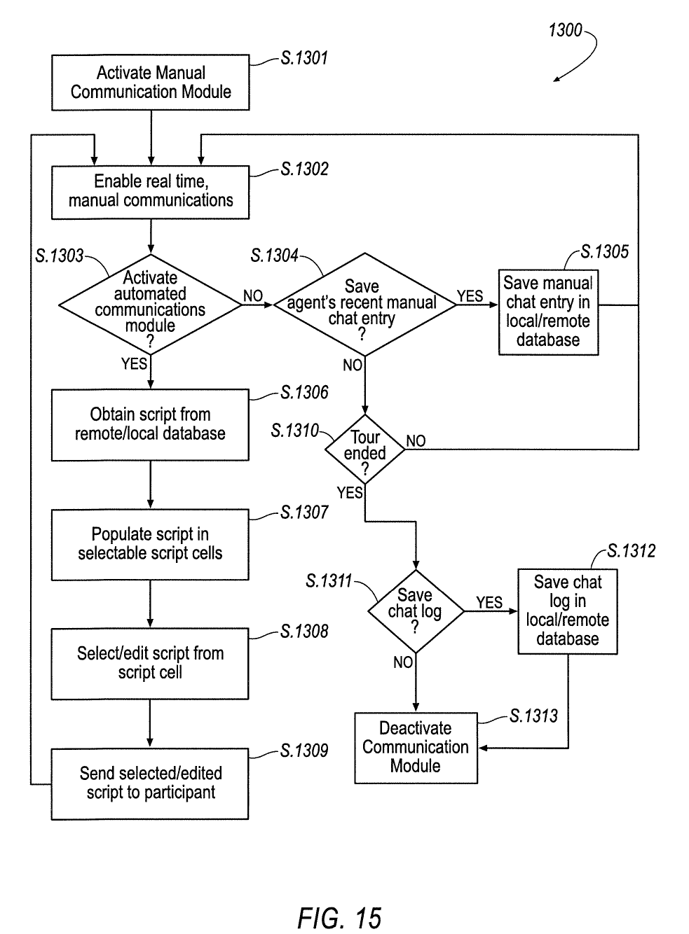

Referring now to FIGS. 9A and 9B, a flow chart 800 for operating the system and method 600 from the educational institution representative computer terminal side is shown according to an embodiment. First, at step S.801, a live representative 606 (i.e. a person) or a virtual representative 606 (i.e., an automated program) navigates/accesses the virtual environment, with, for example, an assigned username/password. Then, at step S.802, the educational institution representative 606 may receive a request to chat with a potential donor 604; alternatively, the educational institution representative 606 may locate a potential donor 604 in the virtual environment at step S.803 for unsolicited chatting. Upon engaging the potential donor 604 at either step S.802 or S.803, the chat module 632 is invoked at step S.804 from the educational institution representative computer terminal side as illustrated in FIG. 7.

At step S.805, the educational institution representative 606 may receive a request from the potential donor 604 for a tour of the virtual environment. If a tour is requested, the educational institution representative 606 may obtain control of the potential donor's navigation capabilities at step S.806. During the course of the tour, the educational institution representative 606 and/or the potential donor 604 may modify or otherwise collaboratively edit the virtual environment, thereby invoking the environment modification module at step S.808. Upon completing the tour and environment modifications, the changes to the virtual environment and chat log may be saved at step S.809. Then, at step S.810, the educational institution representative 606 and/or potential donor 604 may end the tour and exit the virtual environment.

As such, it will be appreciated that system and method 600 is useful in a number of applications for the benefit of utilizing interactive graphics for soliciting and securing financial gifts from potential donors to an educational institution. Potential donors 604 that may be remotely located from the educational institution, or, for example, challenged with computer literacy or lacking in proficient hand-eye coordination may benefit by seeing what a building, landscaping, signage, or the like may look like if a donation or grant is to be given to the educational institution. Additionally, the educational institution 606 may benefit may holding a virtual meeting and sale-pitch to the potential donor 604 in a way that maximizes efficiency in the donation/grant solicitation process.

Referring now to FIGS. 10-15, another embodiment of the invention is disclosed. As seen in FIG. 10, a system for establishing a virtual environment 1000 includes environment navigation modes, which are shown generally at SC, SA and PSA. The system 1000 also includes several sub-modules, which are shown generally at 1002-1010. The system 1000 operates on the same principles as shown in FIG. 1 and includes the Internet 12, one or more participant terminals 14, one or more agent terminals 16, an internet server 17, an operation module 18, and communication paths 20-25. In an embodiment, as shown in FIG. 10, the sub-modules 1002-1010 and environment navigation modes SC, SA and PSA are provided by the operation module 18.

As discussed above, the system 1000 includes several sub-modules 1002-1010 provided by the operation module 18. The sub-modules 1002-1010 are hereinafter referred to as “modules.” Although the modules 1002-1010 are provided by the operation module 18, it will be appreciated that the modules 1002-1010 may be contained, located or otherwise stored or grouped in any desirable manner.

As illustrated, the module 1002 is accessible by one or more participants, P1, by way of the one or more participant terminals 14. The module 1002 is referred to as a navigation mode selection module that permits one or more participants, P1, to select, and, if desired, switch between the environment navigation modes, SC, SA, PSA during the course of their interaction with a virtual environment, VE (FIG. 12). The function of the navigation modes, SC, SA, PSA are described in greater detail in the foregoing disclosure.

In general, the module 1004 is accessible by both a participant, P1, and an agent, P2. The module 1004 is referred to as a manual communications module that permits and provides a communication interface between the one or more participants, P1, and an agent, P2. The mode of communication provided by the manual communication module 1004 may include, for example, text chatting, voice-over-IP (VoIP), or the like. Accordingly, if text is the mode of communication, the text may be entered by the participant or agent P1, P2 by way of their respective terminals 14, 16. If, for example, the mode of communication is voice-over-IP, a microphone or the like may be included with the terminals 14, 16 to transmit voice data over the Internet 12.

The modules 1006-1010 are accessible and utilized by the agent, P2. For example, the module 1006 is referred to as a manual navigation module that permits the agent, P2, to navigate the virtual environment, VE. The module 1008 is an automated navigation module and permits the agent, P2, to obtain and activate an automated navigation of the virtual environment, VE, which will be explained in the foregoing disclosure in FIG. 14. If desired, the agent, P2, may select either of the modules 1006, 1008 at the outset of the agent's interaction with the virtual environment, VE, or, alternatively, the agent, P2, may select the manual navigation module, then, at any time, may elect to navigate the virtual environment, VE, in an automated fashion such that the automated navigation module 1006 is subsequently selected.

Similar to the above description, the module 1010 is an automated communications module. The automated communications module 1010 permits the agent, P2, to obtain and communicate pre-scripted text and/or voice to the participant, P1, which will be explained in the foregoing disclosure in FIG. 15.

Referring now to FIGS. 10-12, wherein the navigation modes SC, SA, PSA are now explained in greater detail. Firstly, the environment navigation mode, SC, is referred to as an independent, “self-control” mode. Secondly, the environment navigation mode, SA, is referred to as a “surrender-to-agent” control mode. Lastly, the navigation mode, PSA, is referred to as a “partial surrender-to-agent” control mode.

In general, the navigation modes SC, SA, PSA represent a point-of-view control that is established within the virtual environment, VE. As seen in FIGS. 11A-11C, a point-of-view of the virtual environment, VE, for a participant, P1, is represented on the monitor, M1, of the participant terminal 14, and, similarly, a point-of-view for an agent, P2, is represented on the monitor, M2, of the agent terminal 16 in FIG. 11B. Although a followed, “over-the-shoulder” point-of-view of a participant, P1, or agent, P2, is shown in FIGS. 11A-11C, it will be appreciated that the point-of-view may alternatively be a first-person perspective point-of-view such that the virtual environment, VE, representation on the monitor, M1, M2, is presented from what would be seen “by the eyes” of the participant, P1, or agent, P2. When a point-of-view is presented “by the eyes” of the participant, P1, or agent, P2, it said that the participant, P1, or agent, P2, is in the avatar mode.

In the following description, an “avatar,” for example, is a term that refers to an electronic, human-like image that may be manipulated by a computer user (i.e., the participant, P1, or agent, P2). Accordingly, in the foregoing disclosure, it will be appreciated that a participant/agent P1, P2 that is interfacing with a computer terminal 14, 16 is a real-life person and that manifestation of a participant/agent P1, P2 within the virtual environment, VE, may be referred to as an avatar. Accordingly, although the participant and agent P1, P2 in FIG. 10 are meant to represent actual persons, it will be appreciated that the participant and agent P1, P2 represented in FIGS. 11A-12 are electronic images displayed on a video display device. These images are manipulated to carry out instructions of the real-life participant and agent P1, P2 in FIG. 10. Thus, in the foregoing description, any discussion relating to the electronic representation of the participant and agent P1, P2 will be accompanied by the word “avatar.”

Further, in the following description, a point-of-view may be referred to as a “camera” position and orientation associated with the participant avatar, P1, and/or agent avatar, P2. The camera position/orientation is displayed on the respectively associated computer monitor, M1, M2, of the participant terminal 14 and/or agent terminal 16.

In a three-dimensional, X-Y-Z virtual coordinate system, the “camera position” may be referred to from a topographical X-Y-Z location of a participant/agent avatar, P1, P2 within a virtual environment (see, e.g., FIG. 12) whereas the “camera orientation” may be associated with a viewing direction of the camera as referenced from the X-Y-Z location of the participant/agent avatar, P1, P2. Accordingly, for example, if a participant/agent avatar P1, P2 is walking or flying, the X-Y-Z position of the camera is said to be moving. If, for example, a participant/agent avatar P1, P2, is either stationary or walking and looks to the left, right, up or down, the orientation of the camera is described to be panned in a different direction/pitch.

Referring now to FIG. 11A regarding the self-control mode, SC, the participant, P1, may, for example, request/accept a virtual tour of the virtual environment, VE, from an agent, P2. Mapping algorithms will then provide the X-Y-Z position and orientation of a camera (see, e.g., FIG. 13, steps S.1101-S.1102). In an embodiment, the participant avatar, P1, may be located in a virtual corridor, C, of a virtual building on a virtual college campus such that the agent avatar, P2, acts as a virtual tour guide for one or more participants, P1.

As seen in FIG. 10 in an embodiment, the operation module 18 may be programmed with a default setting that automatically places the participant, P1, in the self-control mode, SC, when first accessing the virtual environment (see also, e.g., FIG. 13, step S.1103). Subsequently, the navigation selection module 1002 may permit the participant, P1, to choose to be switched from the SC mode to the SA or PSA mode (see, e.g., FIG. 13, steps S.1104-S.1108). After switching to the SA or PSA modes, at any time, the navigation selection module 1002 may permit the participant, P1, to elect to be switched back to the self-control mode, SC (see, e.g., FIG. 13, steps S.1104-S.1108).

In general, the self-control mode, SC, provides the participant, P1, with the ability to navigate the virtual environment at his/her will. As seen in FIGS. 11A and 12, in the self-control mode, SC, the camera point-of-view provided on the participant's computer monitor, M1, is referenced from the X-Y-Z location of the participant avatar, P1, within the virtual environment, VE. Further, the participant, P1, may also control the orientation of the camera in the self-control mode, SC.

In an exemplary embodiment concerning the self-control mode, SC, the participant avatar, P1, may be located in a corridor, C, of a building on a college campus such that the agent avatar, P2, acts as a tour guide for one or more participants, P1 (see, e.g., FIGS. 11A and 12). If, for example, the participant, P1, chooses to follow the tour guide avatar, P2, the participant, P1, may do so by manipulating the position and orientation of the camera referenced from the participant avatar's X-Y-Z location in the virtual environment, VE. If desired, the participant, P1, may effectively leave the virtual tour conducted by the tour guide avatar, P2, at any time such that the participant, P1, navigates an X-Y-Z portion of the virtual environment that is remote from the X-Y-Z location of the agent avatar, P2.

Referring to FIGS. 10 and 11B, a surrender-to-agent control mode, SA, may be selected from the selection module 1002 by the participant, P1 (see, e.g., FIG. 13, steps S.1105-S.1106). In the surrender-to-agent mode, SA, the participant, P1, effectively surrenders all navigational and camera orientation controls of the self-control mode, SC, over to the tour guide, P2. When the surrender-to-agent mode, SA, is selected, the virtual representation of the participant avatar, P1, may be maintained in the virtual environment, however, the virtual environment point-of-view that is provided on the participant's computer monitor, M1, may be snapped from the point-of view of the participant avatar, P1, (see, e.g., FIG. 11A) to that of the tour guide avatar, P2, (see, e.g., FIG. 11B). When snapped-to the point-of-view of the tour guide avatar, P2, the participant's view of the corridor, C, appears to be “through the eyes”/“from the point-of-view” of the tour guide avatar, P2. Accordingly, the virtual representation of the participant avatar, P1, may still exist within the virtual environment as seen in FIG. 11B such that the participant avatar, P1, follows the tour guide avatar, P2, when the tour guide avatar, P2, changes his/her X-Y-Z location within the virtual environment.

Referring to FIGS. 10 and 11C, a partial surrender-to-agent control mode, PSA, may be selected from the selection module 1002 by the participant, P1 (see, e.g., FIG. 13, steps S.1107-S.1108). In the partial surrender-to-agent mode, PSA, the participant, P1, surrenders some, but not all, of the navigational and camera orientation controls associated with the self-control mode, SC, over to the tour guide, P2.

When the partial surrender-to-agent mode, PSA, is selected, the tour guide, P2, for example, may retain partial camera control such that the X-Y-Z positioning of the camera within the virtual environment, VE, is decided by the tour guide, P2. However, if, for example, the tour guide, P2, is proximate an X-Y-Z location of, for example, artwork, A, in the corridor, C, the participant, P1, may effectively retain partial control over the camera by panning the camera point-of-view toward the art, A, such that the participant, P1, may obtain an improved view of the art, A, on the participant monitor, M1, by changing the orientation of the camera (see, e.g., FIG. 13, step S.1108). It will be appreciated that if multiple participants, P1, have selected the PSA mode and are therefore at least partially anchored to the point-of-view of the tour guide avatar, P2, a panning of the camera by one participant, P1, as described above may not upset the point-of-view provided on the agent's computer monitor, M2, or the point of view provided on the other participant's computer monitor(s), as shown, for example, in FIG. 11B.

As mentioned above, it will be appreciated that the participant, P1, may, at any time, stay in or switch between any of the modes, SC, SA, PSA (see, e.g., FIG. 13, step S.1109). If the participant, P1, desires to end the virtual tour, the participant, P1, may do so at any time by selecting an end tour function (see, e.g., FIG. 13, step S.1110).

As applied to the above-example regarding tours of a virtual college campus/building, the system 1000 may be repetitively administered by, for example, the same real-life agent, P2, in order to provide real-time exchanges with, for example, new, unique participants, P1. As such, if a live agent, P2, delivers the same tour repetitively over time, it will be appreciated that the system 1000 may also include automated controls to assist live agents, P2, by relieving some or all of the operation of the chat and/or navigation functions associated with the modules 1004, 1006.

Referring now to FIGS. 10 and 14, for example, at least partial automated control over the navigation of the virtual environment, VE, from the agent terminal 16 may be provided by the automated navigation module 1008. At step S.1201, for example, the system 1000 may be defaulted to operate with the manual navigation module 1006. In the event that the agent, P2, would prefer to focus his/her efforts into chatting with the participants, P1, in favor of manually navigating the virtual environment, the agent, P2, may download a prescribed navigation path, NP (see, e.g., FIG. 12), from a remote, centralized or local database (see, e.g., steps S.1202-S.1203).

Alternatively, rather than downloading the navigation path, NP, it will be appreciated that the agent, P2, may select any one of a previously edited/saved navigation path, NP, from the agent's local database that is stored on, for example, the agent terminal 16. As seen at steps S.1203-S.1206, it will be appreciated that the agent, P2, may have previously saved a navigation path, NP, from a manually navigated tour of the virtual environment by sequentially dropping virtual anchors/targets, A1-A7 (see, e.g., FIG. 12), at selected X-Y-Z locations in the virtual environment, VE.

Referring to FIG. 12 and steps S.1208 and S.1209 in FIG. 14, the navigation path, NP, may be defined, in an embodiment, to include sequential X-Y-Z locations of anchors or targets, A1-A7, that act as individual homing-beacons that cause the agent avatar, P2, to move from a first X-Y-Z position of a first anchor/target, such as, for example, A1, to a subsequent X-Y-Z location of a subsequent anchor/target, such as, for example, A2, within the virtual environment, VE. As such, when a plurality of anchors/targets, A1-A7, are strategically located in a virtual environment, VE, the plurality of anchors/targets, A1-A7, define a sequential navigational path, NP, that alleviates the duty of manually moving the agent avatar, P2, according to inputs at the agent computer terminal 16; rather, the agent, P2, may merely press a single button or key at the agent computer terminal 16 to cause the agent avatar, P2, to automatically see the homing beacon of a target/anchor, A1-A7, to move from a first anchor/target, A1, to a subsequent anchor/target, A2.

In another automated aspect of the invention shown in FIG. 15, for example, if the manual communication module 1004 is activated by one or more of the participants, P1, and/or agent, P2, an option of a real-time dissemination of “canned,” pre-loaded script may be provided to the agent, P2, by way of an invocation of the automated communications module 1010. As seen at steps S.1301-S.1303, in the event that the agent, P2, would prefer to focus his/her efforts into navigating the virtual environment, VE, in favor of chatting with the participants, P1, the agent, P2, may selectively obtain text script(s) from a centralized database associated with the automated communication module 1010. Alternatively, as similarly described above regarding the automated navigation module 1008, the agent, P2, may have at his/her disposal a listing of previously edited/saved text script(s) from a local database (see, e.g., steps S.1303-S.1305). Regardless of how the script is obtained (see, e.g., steps S.1306-S.1307), the agent, P2, may select any one of a plurality of available phases, questions, or the like (see, e.g., step S.1308) from a field of script cells that are displayed on the agent's monitor, M2.

Once the script cell is selected, the agent, P2, may edit the selected script in an editing field prior to broadcasting the phrase, question or the like to the one or more participants, P1 (see, e.g., step S.1309). In order to prevent redundancy of the selected script, the script cells may be color-coded to remind the agent, P2, what automated phrases, questions or the like have been presented to the participants, P1.

Further, as seen at steps S.1310-S.1313, the entire chat log may be saved. For example, if the agent, P2, is a tour guide for a plurality of potential student candidates, P1, entering a freshman class, the agent, P2, may identify a particularly interesting potential student participant, P1, during the tour or after the tour has concluded and decide to save the chat log for future reference by an admissions officer associated with the college. If desired, the agent, P2, may save the chat log with an appropriate name for cataloging and retrieval purposes. Although the “save chat log” is described in conjunction with the automated communications module 1010, it will be appreciated that such a function may also be incorporated into the manual communication module 1004.

Further, it will be appreciated that the system 1000 may include embedded features that may be accessed by the participants, P1, and/or agent, P2. For example, if the art, A, shown in FIGS. 11A-11C was painted by a well-known painter, one or more of the participants, P1, and/or agent, P2, may click on the art, A, to access information about the art, A, (i.e., year the art, A, was made, classification of art, A, name of artist that created it, etc.). The accessed information may be provided, for example, in a file that is associated with the mapping algorithm program of the virtual environment, VE. In an embodiment, when the file is accessed, the view of the virtual environment, VE, on the monitor, M1, M2 may be altered to display text, streaming video, or the like. Further, in an embodiment, by clicking on the art, A, an embedded link may be provided that at least partially alters the view of the computer monitor, M1, M2, to display, for example, a web page from the world wide web. The web page may include, for example, information pertaining to the year the art, A, was made, classification of art, A, name of artist that created it, and the like.

Further, it will be appreciated that the agent, P2, may have certain authoritative controls over the virtual environment. For example, if one of the participants, P1, becomes disruptive during the virtual tour, the agent, P2, may be empowered with the authority to disconnect one or more of the communication module 1004 and/or self-control, SC, mode by, for example, first clicking on the disruptive participant avatar, P1, and then clicking a disable communication module function, F1 (see, e.g., FIG. 12). Further, the agent, P2, may disconnect a disruptive participant, P1, from the tour altogether by, for example, first clicking on the disruptive participant avatar, P1, and then clicking a tour suspension function, F2.

Yet even further, if a participant, P1, becomes topographically lost in the virtual environment, VE, the participant, P1, may access an X-Y map, M, (see, e.g. FIG. 12) to discover the location of the agent avatar, P2, and/or other participant avatars in reference to the location of the participant's avatar on the X-Y map, M. Accordingly, if desired, the participant, P1, may request that he/she is re-joined with the tour by selecting an avatar snap-to function, F3, such that the X-Y-Z location of the participant's avatar is virtually transported to an X-Y-Z location proximate the agent avatar, P2, and/or other participant avatars. Further, if desired, the agent, P2, may independently transport the participant avatar, P1, to any location in the virtual environment if, for example, the participant, P1, is lost and wants to re-join the tour by selecting the avatar snap-to function, F3.

Further, if one or more participants, P1, for example, are taking a virtual tour of a virtual ‘general studies’ academic building on a virtual college campus, but rather, would prefer to take a virtual tour of a virtual ‘engineering’ academic building, the participant, P1, or agent, P2, may transfer the participant avatar, P1, from a current X-Y-Z location in the general studies building to the virtual engineering academic building by, for example, first clicking on the participant avatar, P1, then clicking on the location of the virtual engineering building from a virtual map of the virtual college campus (not shown) and then clicking a swap avatar location function, F4.

Further, the agent, P2, may transfer/delegate the participant's virtual tour to another tour guide within the engineering academic building that is familiar with the engineering building's virtual environment by, for example, selecting a designated tour guide from a list of selectable tour guides (not shown) and then clicking on a designate-guide function, F5. If, for example, a plurality of participant avatars are transferred to the virtual engineering academic building, the participant avatars may conduct such a request with one voice by identifying their interests as an avatar sub-group. Such specialized interests may be identified/requested by the system 1000 prior to the initiation of the virtual tour if a participant, P1, is offered the opportunity to join a specialized sub-group. Although several specialized functions are described above, it will be appreciated that the system 1000 is not limited to the above-identified functions F1-F5 and may include any desirable function.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A method for interfacing with a virtual environment provided by an operation module, comprising the steps of:
providing an interface for a participant computer terminal to permit a participant to interface with the virtual environment by way of a participant avatar;
providing an interface for an agent computer terminal to permit an agent to interface with the virtual environment by way of an agent avatar; and
providing an avatar navigation selection module that permits said participant to have an option of selecting one of a plurality of virtual environment avatar navigation modes including
an independent, self control mode,
a surrender-to-agent control mode, and
a partial surrender-to-agent control mode.

2. The method according to claim 1, wherein the avatar navigation selection module further comprising the function of switching from selected mode from the plurality of virtual environment avatar navigation modes to an unselected mode from the plurality of virtual environment avatar navigation modes.

3. The method according to claim 1, further comprising the step of:
providing a manual communications module that is accessible by both the participant and agent.

4. The method according to claim 3, further comprising the step of:
providing the agent with authoritative controls by,
limiting the access to one or more of the avatar navigation selection modules and manual communication module.

5. The method according to claim 4, wherein the manual communication module is invoked and providing the ability to save at least a portion of a dialogue between the participant and the agent.

6. The method according to claim 1, further comprising the steps of:
providing a manual navigation module;
providing an automated communication module; and
providing an automated navigation module that, wherein the manual navigation module, the automated communication module and the automated navigation modules are exclusively accessible by the agent.

7. The method according to claim 6, wherein the automated communications module includes:
obtaining one or more pre-scribed phrases from a remote or local database;
selecting one of the one or more pre-scribed phrases; and
sending the selected pre-scribed phrase from the agent to the participant.

8. The method according to claim 6, wherein the automated navigation module includes:
obtaining one or more predefined navigational paths of a virtual environment from a remote or local database;
selecting one of the one or more predefined navigations paths; and
automatically moving the agent avatar along the predefined navigational path.

9. The method according to claim 8, further comprising the step of:
predefining the navigational path prior to navigating the virtual environment comprising the steps of,
manually moving the agent avatar to a first location in the virtual environment and placing a first homing-beacon anchor; and
manually moving the agent avatar to one or more second locations in the virtual environment and placing one or more second homing-beacon anchors to define the predefined navigational path.

10. The method according to claim 1, further comprising the step of:
providing an embedded file in a mapping algorithm of the virtual environment; and
accessing the embedded file and displaying data contained in the embedded file.

11. The method according to claim 1, further comprising the step of:
providing an embedded Internet link in a mapping algorithm of the virtual environment; and
accessing the embedded Internet link and displaying a world wide web page referenced by the Internet link.

12. The method according to claim 1, further comprising the step of:
transporting the participant avatar from a first location in the virtual environment to a second location in the virtual environment.

13. The method according to claim 1, further comprising the steps of:
providing assistance from the agent to the participant in the virtual environment;
locating an available agent; and
delegating the provided assistance from the agent to the available agent.

14. A system for interfacing with a virtual environment provided by an operation module including a plurality of avatar navigation modes, comprising:
a participant computer terminal coupled to the operation module that permits a participant to interface with the virtual environment by way of a participant avatar;
an agent computer terminal coupled to the operation module that permits an agent to interface with the virtual environment by way of an agent avatar;
an avatar navigation selection module disposed in the operation module; wherein the avatar navigation selection module permits said participant to have an option of selecting one of a plurality of virtual environment avatar navigation modes including
an independent, self control mode,
a surrender-to-agent control mode, and
a partial surrender-to-agent control mode.

15. The system according to claim 14, further comprising:
a manual communications module that is accessible by both the participant and agent.

16. The system according to claim 14, further comprising:
a manual navigation module;
an automated communication module; and
an automated navigation module that, wherein the manual navigation module, the automated communication module and the automated navigation modules are exclusively accessible by the agent.

17. The system according to claim 16, wherein the automated navigation module includes a predefined navigational path of a virtual environment defined by a series of homing-beacon anchors located in the virtual environment.

18. The system according to claim 14, further comprising:
an embedded file in a mapping algorithm.

19. The system according to claim 14, further comprising:
an embedded Internet link in a mapping algorithm.
